(19) United States
(12) Patent Application Publication
(10) Pub. No.: US 2026/0120192 A1
(43) Pub. Date: Apr. 30, 2026

(54) SYSTEM AND METHOD OF DETERMINING A RISK PROFILE FOR A DWELLING

(71) Applicant: JOJO TECHNOLOGIES LTD., Surrey (CA)

(72) Inventor: Paul Justin CARLSON, Surrey (CA)

(73) Assignee: JOJO TECHNOLOGIES LTD., Surrey (CA)

(21) Appl. No.: 19/009,073

(22) Filed: Jan. 3, 2025

Related U.S. Application Data
(63) Continuation of application No. PCT/CA2022/051414, filed on Sep. 23, 2022.
(60) Provisional application No. 63/359,165, filed on Jul. 7, 2022.

(51) Int. Cl. G06Q 40/08

(52) U.S. Cl. CPC G06Q 40/08

(57) ABSTRACT

There is provided a method of determining a risk profile for a dwelling. The method includes: determining whether the dwelling is being monitored, the type and extent of dwelling sensors within the dwelling, and the extent to which a security alarm system of the dwelling is activated; adjusting the risk profile in response to said determining; sending the risk profile so adjusted to an insurance provider or broker; and obtaining an insurance quote based on the same. There is also provided a security alarm assembly including dwelling sensors, a security alarm system in communication with the dwelling sensors, and a processor. The processor is configured to determine the number and type of said dwelling sensors, determine the extent to which the security alarm system is activated, determine whether the security alarm assembly and/or the dwelling sensors are monitored, and calculate a risk profile based on the same.

### BACKGROUND OF THE INVENTION

### Field of the Invention

There is provided a system and method of determining a risk profile. In particular, there is provided a system and method of determining a risk profile for a dwelling. There is also provided a method of assessing a homeowner/renter's risk profile and providing insurance rates based on the same.

### Description of the Related Art

U.S. Pat. No. 10,699,348 to Ramsey et al. discloses systems and methods with one or more dwelling sensors configured to generate sensor data representative of characteristics of a dwelling. The systems and methods include a telematics device configured to generate telematics data representative of operational characteristics of a vehicle. The systems and methods include an analysis server which receives the sensor data, receives the telematics data, receives credit information regarding an insured, and determines one or more insurance policy decisions based upon the sensor data, the telematics data, and the credit information. The one or more insurance policy decisions comprise: a premium amount, a deductible amount, a coverage amount, a coverage term, or any combination there of for the insured.

U.S. Pat. No. 11,100,590 to Baker discloses a system and method for automatically detecting if a home alarm system is being used and/or actively monitored. The system and method use data gathered from one or more sensors, including audio information from microphones. The audio information is analyzed using a machine learning system to determine if the alarm system is being regularly used and monitored. The system and method can also automatically update a policy holder's insurance policy to reflect whether or not an alarm system is being used.

United States Patent Application Publication No. 2010/0138244 A1 to Basir discloses a vehicle usage monitoring system. The privacy of the user is protected by performing some coding prior to sending the information from the user. Specific details of the user's driving history are converted to generalized codes that relate to insurance rates. Different types of vehicle information may be combined into generating the codes to be sent from the user in order to provide even more privacy. The codes may be used to calculate a vehicle insurance rate.

United States Patent Application Publication No. 2014/0136242 A1 to Weekes et al. discloses a computer-implemented method of incentivizing low-loss behaviors. In-home data is received and generated by, or based on information generated by, a device located at a residence of an individual, and is indicative of one or both of (i) a utilization of the device and (ii) a condition monitored by the device. The method also includes determining, based on the received in-home data, an insurance premium adjustment for the individual, and providing an indication of the determined insurance premium adjustment.

U.S. Pat. No. 10,713,726 to Allen et al. discloses a system may include sensors associated with structures, such that the sensors acquire data sets associated with the structures. The processor receives the data sets from the sensors, determines environmental conditions associated with the structures over a period of time, and determines a structural condition associated with one of the structures based on the data sets. The processor also determines a maintenance condition associated with the one of the structures based on one of the data sets, determines operating parameters associated with appliances within the structure based on the one of the data sets, and determines habits of occupants associated with the one of the structures based on the one of the data sets. The processor then adjusts properties of an insurance policy associated with the one of the structures based on the environmental conditions, the structural condition, the maintenance condition, the operating parameters, the habits, or any combination thereof.

U.S. Pat. No. 10,664,922 to Madigan et al. discloses systems, methods, apparatuses and computer-readable media for receiving data from one or more sensors or devices associated with one or more users are presented. In some examples, data may be filtered and analyzed to determine a risk profile for a user. In addition, the system may also determine a neighborhood risk profile for a number of users located in the same geographical location. The risk profile and the neighborhood profile may be used to determine or adjust a user's insurance premiums.

### BRIEF SUMMARY OF INVENTION

There is provided, and it is an object to provide, an improved system and method of determining a risk profile for a dwelling as described herein.

There is provided a method of determining a risk profile for a dwelling. The method includes determining whether the dwelling is being monitored and adjusting the risk profile from a base line in response thereto. The method includes determining the type and extent of dwelling sensors within the dwelling and further adjusting the risk profile in response thereto. The method includes determining the extent to which a security alarm system of the dwelling is activated and yet further adjusting the risk profile in response thereto. The method includes sending the risk profile so determined to an insurance provider or broker and obtaining an insurance quote based on the same.

There is further provided a security alarm assembly according to one aspect. The assembly includes one or more dwelling sensors. The assembly includes a security alarm system in communication with the one or more dwelling sensors. The assembly includes a processor. The processor is configured to: determine the number and type of said one or more dwelling sensors, the extent to which the security alarm system is activated, and whether one or more of the security alarm assembly or the one or more dwelling sensors are monitored; and calculate a risk profile based on said determinations. The assembly is configured to send the risk profile so determined to an insurance provider or broker and obtain an insurance quote based on the same.

There is also provided a computer program product comprising a medium carrying computer readable instructions which, when executed by a processor, causes the processor to execute a method of determining a risk profile for a dwelling. The method includes determining whether the dwelling is being monitored and adjusting a base line said risk profile in response thereto. The method includes determining the type and extent of dwelling sensors within the dwelling and further adjusting the risk profile in response. The method includes sending the risk profile so determined to an insurance provider and obtaining an insurance quote based on the same.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a schematic view of a system for determining a risk profile for a dwelling according to one embodiment, the system being configured to determine a risk profile for a dwelling based on a determination of the type and extent of dwelling sensors and smart home devices detected, based on a determination of the extent to which the dwelling is monitored and based on a determination of the extent to which the security alarm assembly and components thereof are used;

FIG. 2 is a schematic view of a system for determining a risk profile for a dwelling, the system being similar to FIG. 1 and according to another embodiment;

FIG. 3 is a schematic view of a system for determining a risk profile for a dwelling, the system being similar to FIG. 2 and according to a further embodiment;

FIG. 4 is a schematic view of a system for determining a risk profile for a dwelling, the system being similar to FIG. 1 and according to an additional embodiment;

FIG. 5 is a flowchart of a detection algorithm setting out dwelling sensor and smart home device criteria for detection by the system of any one of FIGS. 1 to 4, with the presence or absence of said factors being used to lower or increase a risk profile score for a person/dwelling;

FIG. 6 is a flowchart of a monitoring algorithm setting out monitoring factors taken into account by the system of any one of FIGS. 1 to 4, with the presence or absence of said factors being used to lower or increase a risk profile score for a person/dwelling; and

FIG. 7 is a flowchart of an activation algorithm setting out activation factors taken into account by the system of any one of FIGS. 1 to 4, with the presence or absence of said factors being used to lower or increase a risk profile score for a person/dwelling.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

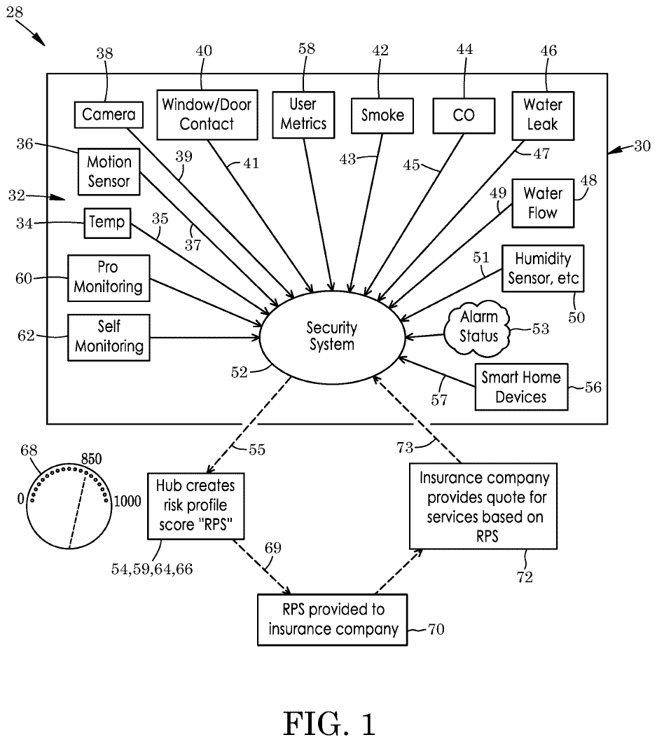

Referring to the drawings and first to FIG. 1, there is shown a system 28 for determining a risk profile for a dwelling 32 and a method of operating the same. The system includes in this non-limiting example a security alarm system 30.

The security alarm assembly includes one or more of a plurality of dwelling sensors, such as one or more temperature sensors 34, one or more motion sensors 36, one or more optical sensors or cameras 38, one or more window/door sensors 40 (or contacts), one or more smoke detectors 42, one or more carbon monoxide (CO) sensors 44, one or more water leak sensors 46, one or more water flow sensors 48, and/or one or more humidity sensors 50, for example. This set of dwelling sensors is non-exclusive, is not intended to be limiting, and dwelling 32 may include fewer dwelling sensors or additional dwelling sensors not listed above in other embodiments.

Security alarm assembly 30 includes a security alarm system 52. The security alarm system is in communication with, is operatively connected to and receives data or input from the plurality of dwelling sensors 34, 36, 38, 40, 42, 44, 46, 48 and 50 in this example as shown by arrows of numerals 35, 37, 39, 41, 43, 45, 47, 49 and 51. Security alarm system 52 may include a disarm mode and two arm modes. The first arm mode may be a “stay” mode where an alarm 53 is triggered upon one or more door/window sensors 40 indicating that one or more windows or doors have been or are in the process of being opened. The second arm mode may be an “away” mode where motion sensors 36 are also activated and the alarm is triggered upon either the window/door sensors detecting one or more windows/doors being opened or the motion sensors detecting motion within dwelling 32. Alarm status 53 is in communication with security alarm system 52 and conveys whether the alarm has been triggered or not for example.

Security alarm assembly 30 may include one or more smart home devices 56. Security alarm system 52 is configured to be in communication with, operatively connect to and receive data or input from the smart home devices as shown by numeral 57. Smart home devices 56 may originate from one or more third party devices, with security alarm assembly 30 being configured with processor/software/communication-module capabilities to communicate wirelessly with such devices via standard or proprietary communication protocols. The smart home devices may include one or more of smart hubs, smart appliances (e.g. smart refrigerators, smart air conditioning, smart ovens, smart cookers etc.), smart showers, smart mattresses, smart thermostats, smart speakers, smart displays and the like, other security devices (e.g. smart doorbells, smart locks etc), smart plugs, and smart lighting systems (e.g. smart bulbs etc.) for example. This set of smart home devices is non-exclusive, is not intended to be limiting, and dwelling 32 may include fewer smart home devices, no such smart home devices, or additional smart home devices not listed above in other embodiments. At least one of smart home devices 56 may comprise or incorporate internet of things (IoT) devices. At least one of the smart home devices may comprise artificial intelligence for example.

Security alarm assembly 30 may include professional monitoring of security alarm system 52 as shown by box 60. This may be but need not necessarily be provided via a third party monitoring service. In addition or alternatively, the security alarm system may be self-monitored, as shown by box 62. Self-monitoring may include monitoring via a person occupying dwelling 32 or via a dwelling resident remotely monitoring the dwelling periodically or in real-time.

Security alarm assembly 30 includes user metrics 58 and may take into account data resulting from the same. Non-limiting examples of user metrics may include the extent to which the dwelling sensors 34, 36, 38, 40, 42, 44, 46, 48 and 50 and/or other components of dwelling 32 operatively connected to the security alarm system such as smart home devices 56, are used or activated as determined by security alarm system 52 for example. The security alarm system may be configured to receive one or more signals indicative of such use or activation and store the same in memory thereof.

User metrics 58 may also include the extent to which the dwelling sensors and/or smart home devices are maintained or replaced. Security alarm assembly 30 may include in memory thereof data about various of the devices coupled thereto, including manufacturer provided or standard best-practice provided maintenance and device replacement information. Such information may be compared against the actual user-directed maintenance or replacement of the devices, with security alarm assembly 30 making a determination based on the same.

User metrics 58 may include the extent to which a person is within dwelling 32 for example. The user metrics may include patterns/routines of the person as related to the dwelling and determined by one or more dwelling sensors 34, 36, 38, 40, 42, 44, 46, 48 and 50 and/or smart home devices 56, including information that may affect or influence a determination of risky behavior and/or a determination of whether such patterns are more likely to increase or decrease risk to dwelling 32. Security alarm assembly 30 may include and use machine learning to analyze user metrics 58 and make predictions based on the same to identify factors that may increase or lower a risk profile for a person/dwelling.

Security alarm assembly 30 includes a processor 54. The processor is configured to receive various inputs or data from the various components of the security alarm assembly, including from dwelling sensors 34, 36, 38, 40, 42, 44, 46, 48 and 50 and/or smart home devices 56, and make determinations and/or use machine learning based on the same to identify factors that may increase or lower a risk profile for a person/dwelling. Processor 54 is part of a computing device, in this example a smart hub 59 in communication with security alarm system 52 in this example, as shown by arrow 55; however, this is not strictly required. The processor may alternatively be part of the security alarm system. As a further alternative, processor 54 may be a standalone device, such as part of a mobile device, which is configured to be in communication with the security alarm system, which in turn is in communication with dwelling sensors 34, 36, 38, 40, 42, 44, 46, 48 and 50 and/or other components of dwelling 32 coupled to the security alarm system such as smart home devices 56. As an additional alternative, the processor may be directly in communication with the dwelling sensors and/or smart home devices, as well as security alarm system 52.

Smart hub 59 may include a communication module 64 configured to enable processor 54 to communicate with and receive data from smart home devices 56 made by one or more third party manufacturers using standard or proprietary communication protocols.

System 28 includes software, in this example operating software, in this case an application software 66. The application software may be referred to as a security application or security app. Smart hub 59 in this example is configured to receiving data from security alarm system 52, dwelling sensors 34, 36, 38, 40, 42, 44, 46, 48 and 50, and/or smart home devices 56. Application software 66 is in communication with the security alarm system, dwelling sensors and smart home devices. The application software is configured to provide an interface, in this example a display interface for enabling a user or person associated with or occupying dwelling 32 to centrally monitor security alarm system 52, dwelling sensors 34, 36, 38, 40, 42, 44, 46, 48 and 50, and/or smart home devices 56. Application software 66 is further configured to enable the person associated with or occupying dwelling 32 to selectively adjust, control and/or activate security alarm assembly 30, including components thereof such as security alarm system 52, dwelling sensors 34, 36, 38, 40, 42, 44, 46, 48 and 50, and/or smart home devices 56 for example. Application software 66 in this non-limiting example is downloaded to and part of smart hub 59. However, this is not strictly required and the application software may be downloaded to and apart of security alarm system 52 in one example. As a further alternative, the application software may be downloaded to and be apart of another device of dwelling 32, such as one or more smart home devices 56 and/or smart sensor devices, which may or may not be third party devices.

System 28, and/or components thereof, such as security alarm assembly 30, smart home devices and/or application software 66 thereof, may be referred to as comprising a computer program product with a medium carrying a computer readable set of instructions which, when executed by processor 54, cause the processor to execute a method according to one or more of the above algorithms as herein described and/or subsequently set out claims. Alternatively, the system, and/or components thereof, such as security alarm assembly 30, smart home devices 56 and/or the application software thereof, may be referred to as comprising a computer readable storage medium having a program stored thereon, wherein the program code is arranged so that, when the program code is executed by a computer or computing device, the steps set out in any of the algorithms as herein described and/or subsequently set out claims, are performed.

As described further below, system 28, in this example including security alarm assembly 30, is configured to determine whether the security alarm system is monitored (self monitored or professionally), what type of dwelling sensors are found within or associated with dwelling 32, how often alarm 53 is being used (stay, arm, away), and the variety of dwelling sensors being used (not just security but also lighting and automated scenes etc). Multiple points of data are used to determine via processor 54 a consumers risk level.

System 28 including in this example security alarm assembly 30, creates and includes a sliding risk scale (as shown by numeral 68) which may range in this non-limiting example from 0 to 1000. The system determines via processor 54 a risk score for a given dwelling 32 and person associated with the dwelling based on the above set out factors as well as other factors such as: the types of dwelling sensors 34, 36, 38, 40, 42, 44, 46, 48 and 50 detected/determined-to-be within the dwelling, the types of smart home devices 56 detected/determined-to-be within the dwelling, whether any of the dwelling sensors and/or smart home devices are low battery or non-operational as determined by the processor, and the like.

System 28 may include a device that is mobile and location-aware, such as a mobile device, tablet or the like, which includes a location sensor and/or which includes GPS. In this case the system may enable the person to selectively create a geofence, such as a virtual perimeter about the person's dwelling or property. Processor 54 may be configured to selectively communicate with and/or ping various components of system 28 (dwelling sensors, smart home devices etc.) based on whether a designated person enters or exits the geofence, with the processor making determinations and/or communicating information to the person based on the same. System 28 and security alarm assembly 30, with security alarm system 52 so operatively connected to and in communication with smart home devices 56, such as smart appliances like stoves, may thus enable the security alarm system to identify and notify to the person associated with dwelling 32 that the smart home device such as the smart oven, was left ‘on’ before the person arms the dwelling or prior to the person leaving the dwelling where geofencing is enabled for example.

Processor 54 and/or application software 66 may be configured to output a person's risk profile score so determined by security alarm assembly 30, as shown by arrow 69, to a third party insurance broker/company, as shown by box 70. The insurance broker/company, in response to this risk profile score, may determine or provide an insurance quote proportional or corresponding thereto as shown by box 72 and communicate the same to security alarm system 52 as shown by arrow 73.

Application software 66 may also be configured to provide suggestions to the person associated with dwelling 32 to enable the person to try to improve their risk profile score. For example, if the person has a risk profile score of 850 out of 1000, security alarm assembly 30 may notify the person via application software 66 that by installing water sensor 46 adjacent the person's hot water heater, this could move their risk profile score to a 925 and reduce their monthly premium by $28 etc.

If the person/customer has a security alarm system 52 that is never used, they may receive a risk level score of 400 for example. On the other hand, if the person arms/disarms the security alarm system each day, they may receive a risk level score of 550 for example. If the person monitors security alarm system 52 and has water leak detectors 46 by their laundry and hot water heaters (water damage therefrom may make up 20% of the claims) then the person may obtain a risk profile score of 850 for example. If processor 64 determines or detects that one or more dwelling sensors 34, 36, 38, 40, 42, 44, 46, 48 and 50 and/or smart home devices 56 have a low battery detection feature, such as the case for smoke detectors 42, then the risk level score may be raised to 950 for example. Security alarm assembly 30 as herein described is configured to internally rank the person associated with dwelling 32 on how effectively they use their security alarm system 52, one or more dwelling sensors 34, 36, 38, 40, 42, 44, 46, 48 and 50 and/or smart home devices 56, and monitor their dwelling 32 including the security alarm system, dwelling sensors and/or smart home devices. The security alarm assembly may thus use the risk profile score so determined to interact with insurance brokers/companies, and obtain best/preferred rates for the person associated with dwelling 32 while protecting their privacy as no specifics of how they achieved this score is given to an insurance broker/company.

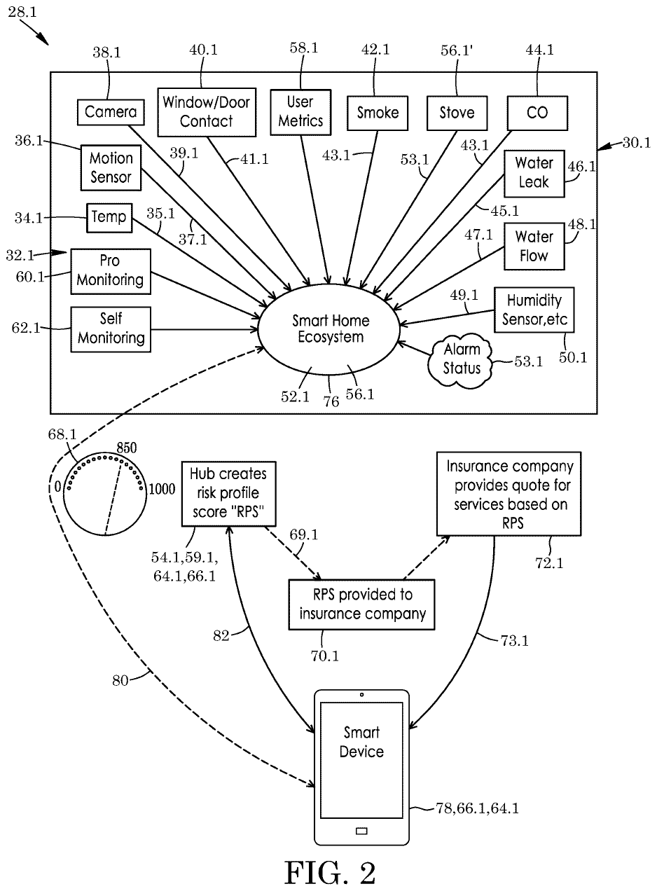

FIGS. 2 to 4 show systems 28.1/28.2/28.3 according to additional aspects. Like parts have like numbers and functions as the system 28 shown in FIG. 1 with the addition of decimal extensions “0.1”, “0.2”, and “0.3”, respectively.

In one embodiment in FIG. 2, smart home devices 56.1 (which may comprise third party systems and/or include smart fridges, ovens, stoves 56.1′, security, lights, etc.) may couple to security alarm system 52.1 in dwelling 32.1 so as to form a smart home ecosystem 76 of system 28.1 and have these smart home devices as well as dwelling sensors 34.1, 36.1, 38.1, 40.1, 42.1, 44.1, 46.1, 48.1 and 50.1 all report into application software 66.1 of a smart device such as mobile device, in this case a smart phone 78. The smart home ecosystem is configured to communicate with and tie into a plurality of third party ecosystems (such as all prominent systems, including those provided by Apple®, Google®, Amazon®etc.) and thus monitor the status of third party devices as well. Smart phone 78 is configured to be in communication with smart home ecosystem 76, as shown by arrow 80. The smart phone is in communication with smart hub 64.1 in this example as shown by arrow 82.

Smart phone 78 may include application software 66.1 that, in conjunction with processor 64.1, creates a risk profile 68.1 based on the customer. Alternatively, the processor may reside in and be part of smart hub 64.1, smart home ecosystem 76 and/or other smart home devices 56.1, for example. Smart phone 78 in this example is in communication with and thus receives discounts or quotes directly from the insurance broker/company, as shown by arrow 73.1, based on the risk profile score so determined by security alarm assembly 30.1.

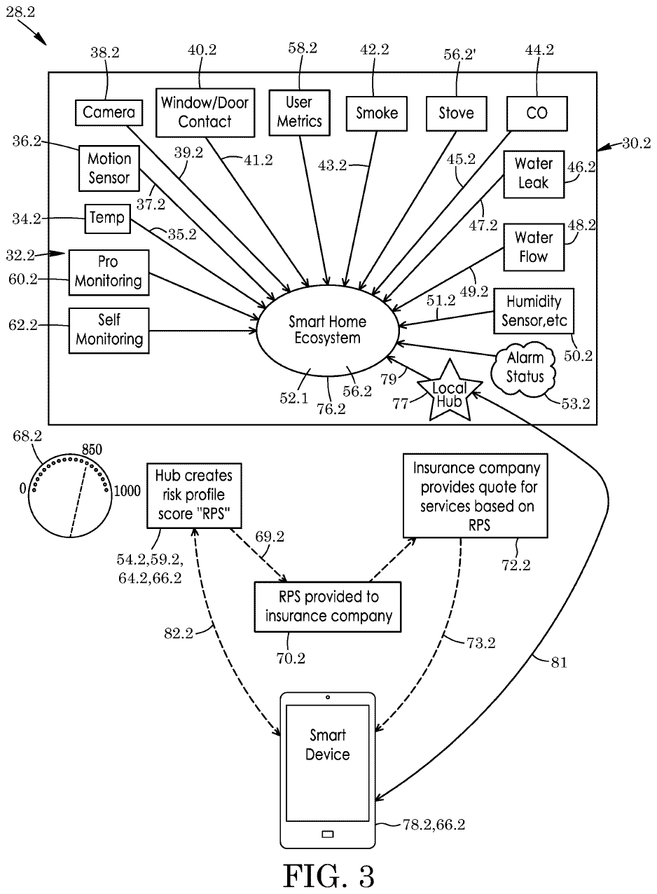

The smart phone may include a location-tracking feature configured to provide geofencing, to create a virtual boundary about dwelling 32.1. In this case smart home ecosystem 76 may be in communication with the smart phone, and security alarm assembly 30.1 may be notified if the person is exiting the virtual boundary, and in response thereto may communicate to the person important information affecting the dwelling and risks relating thereto (e.g. important security alarm system status, dwelling sensor and/or smart home device information etc.). For the embodiments shown in FIGS. 2 and 3, if the person's oven is connected to their Apple®ecosystem, and the person tries to set their security alarm system 52.1 to away and forgets that the oven was left on without setting the alarm, then system 28.1 and in this example security alarm assembly 30.1 with components thereof so integrated, send the person with an alert, such as via their smart phone 78, prior to setting the alarm. This type of integration may be used to lower the person's insurance rates and keep them safer overall.

As seen in FIG. 3, system 28.2 may further include a local smart hub 77 in communication with smart home ecosystem 76.2 as shown by arrow 79, as well as in communication with smart phone 78.2 as shown by arrow 81.

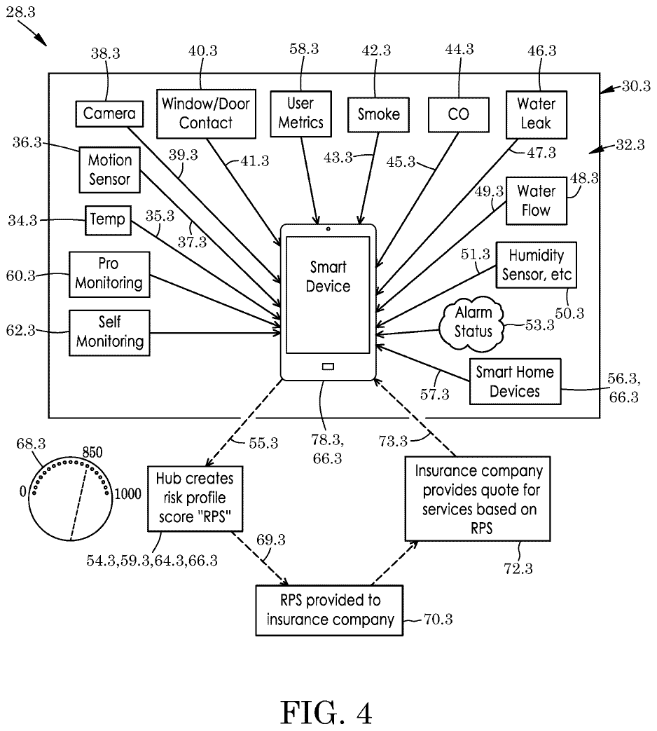

As seen in FIG. 4, system 28.3 may be embodied in software application 66.3 or an app that is downloadable to a smart device, such as smart mobile device or smart phone 78.3 and/or other smart home devices, with the software application being configured to read dwelling sensors 34.3, 36.3, 38.3, 40.3, 42.3, 44.3, 46.3, 48.3 and 50.3 in dwelling 32.3 without the need of security alarm assembly 30 or security alarm system 52 of FIG. 1.

For example, if a person has a smart home device 56.3 in the form of an Apple TV™ and/or Google Home Hub™, and/or smart phone 78.3, the person may download application software 66.3 thereon. The application software is configured to analyze the devices that are connected to the user's dwelling 32.3 and provide a risk profile score to obtain insurance rates through this medium. In this example, as it is application software 66.3 that provides a risk profile for devices 56.3 and/or 78.3 to which the application software is connected to, or behaviours of an individual—like how often the person turns on/off the lights, adjusts a stove, opens a door, etc., system 28.3 may thus comprise downloadable software. In addition or alternatively, system 28.3, including application software 66.3 thereof, may be embedded within a device of an original equipment manufacturer (OEM) and/or operate within a smart thermostat, smart home speaker or the like. Smart home devices 56.3 may be connected to the Internet and used via application software 66.3 of system 28.3 to pass along a risk profile score and provide insurance rates to a user through that products app.

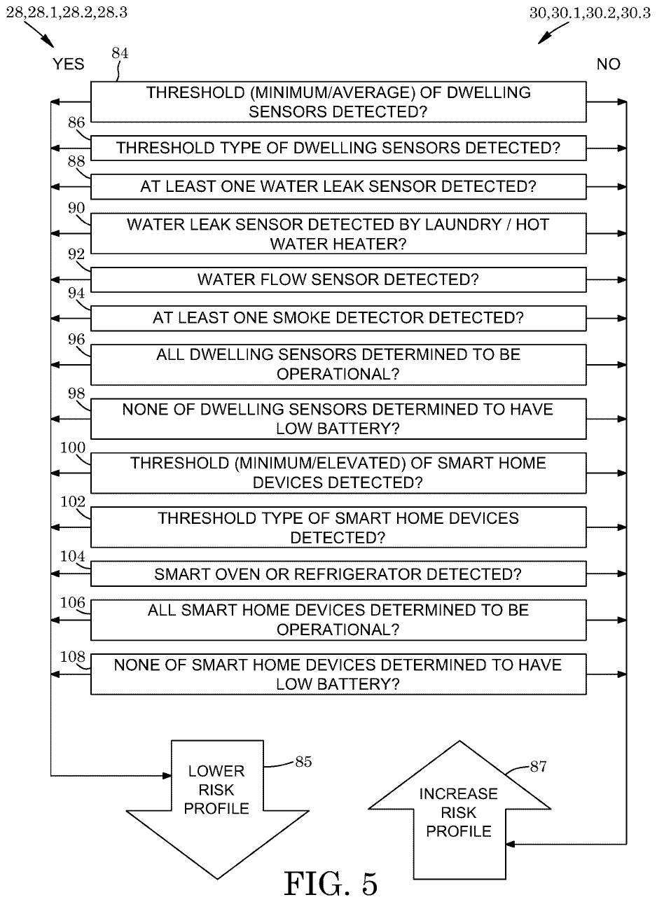

FIG. 5 sets out a non-limiting example of a detection algorithm which may be used by system 28/28.1/28.2/28.3 set out in FIGS. 1 to 4. The processor is configured to determine the type and extent of dwelling sensors within the dwelling and adjust the risk profile in response thereto. In this example as shown by box 84, the processor may be configured to determine whether a minimum number of dwelling sensors are within the dwelling and adjust the risk profile in response thereto, as well as determine whether an above average number of dwelling sensors are in the dwelling and lower the risk profile 85 (and increase the person's effective risk profile score) as a result thereof. If a minimum number of dwelling sensors is not detected and/or if a below average number of dwelling sensors is detected, the risk profile may be increased as shown by box 87 (with a corresponding decrease in the person's effective risk profile score).

In this example and as shown by box 86, the processor is configured to determine whether a threshold type or set of dwelling sensors are detected and lower the risk profile based on the same. For example, as mentioned water leaks may account for over 20% of insurance claims. Thus in this example and as shown by box 88, the processor is configured to determine whether the dwelling sensors include at least one water leak detector and if so, lower the risk profile 85. Lowering the risk profile in this case means that the person's behavior is less risky to a prospective insurance broker/company, with the person's risk profile score being raised/improved, thereby resulting in a lower premium. As a further example and layer of determination as shown in box 90, the processor may be configured to determine whether the dwelling has a water leak detector adjacent the laundry appliance and/or in the laundry room, and/or adjacent the hot water heater and if so, lower the risk profile.

In this example and as shown in box 92, the processor is configured to detect whether the dwelling includes at least one water flow sensor and if so, lower the risk profile 85. In this example and as shown in box 94, the processor is configured to detect whether the dwelling includes at least one smoke detector and if so, lower the risk profile. Detection of the number and extent of smoke detectors for a given type of said dwelling may also be used to increase or decrease the risk profile. The processor may be configured to further detect whether there are water sprinklers within the dwelling and if so, lower the risk profile. Detection of the number and extent of water sprinklers for a given type of said dwelling may also be used to increase or decrease the risk profile.

In this example and as shown in box 96, the processor is configured to determine whether all of the dwelling sensors so detected are operational and if so, lower the risk profile 85. In this example and as shown in box 98, the processor is configured to detect whether one or more of the dwelling sensors have a low battery detection feature and if so, lower the risk profile. The low battery detection feature may emit a signal when the associated device has a low battery or power status, such as audible and/or visual indicators provided by a smoke alarm experiencing a low battery. The extent to which the dwelling sensors are determined to have a lower battery detection feature may be a further layer used by the processor to increase or decrease the risk profile. Similarly, the processor may be configured to detect whether none of the dwelling sensors so detected have a low battery and if so, lower the risk profile 85.

The processor is configured to be in communication with and receive data from the one or more smart home devices within the dwelling. The processor adjusts the risk profile based on data received from the one or more smart home devices. In this example and as shown by box 100, the processor is configured to determine whether a minimum and/or above average thresholds number of smart home devices are detected within the dwelling and if so, lower the risk profile in response thereto.

Some smart home devices may be particularly relevant for determining a risk profile and in this example and as shown by box 102, the processor is configured to determine the type and extent of said one or more smart home devices within the dwelling and adjust the risk profile in response thereto. In this example and as a further layer of detection shown by box 104, the processor is configured to determine whether a smart oven or smart refrigerator is detected and if so, lower the risk profile 85. This may be because smart ovens and refrigerators may have more fail-safe, sensor and/or communication features, thereby reducing the prospects of fire or flooding in the dwelling, respectively, for example.

In this example and as shown in box 106, the processor is configured to determine whether all of the smart home devices so detected are operational and if so, lower the risk profile. The extent to which the smart devices are operational as determined by the processor may comprise a further layer for determining whether the risk profile should be increased or decreased.

In this example and as shown in box 108, the processor is configured to detect whether the smart home devices have a low battery detection feature and if so, lower the risk profile 85. Smart home devices which have such a low battery detection feature may function to notify the processor of a low battery, with the processor in turn functioning to notify the person of the same. This may thereby improve the prospects of the person taking action to replace batteries, thus improving the prospects of the smart devices continuing to remain in operation and in good working order. The extent to which the smart devices have a low battery detection feature as determined by the processor may comprise a further layer for determining whether the risk profile should be increased or decreased. Similarly, the processor may be configured to detect whether none of the smart home devices so detected have a low battery and if so, lower the risk profile and thus raise the person's risk profile score.

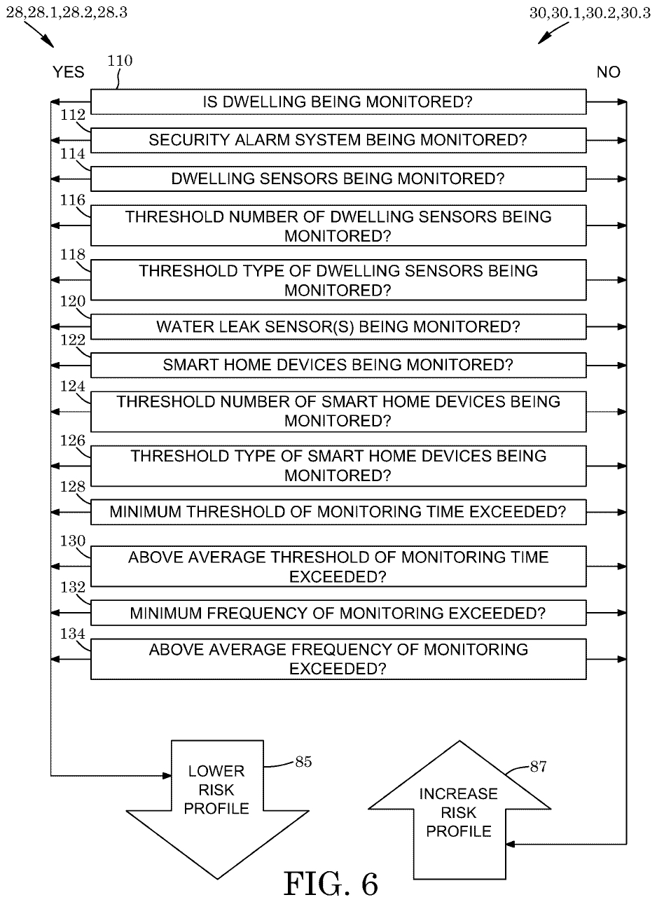

FIG. 6 sets out a non-limiting example of a monitoring algorithm which may be used by systems 28/28.1/28.2/28.3 set out in FIGS. 1 to 4. As shown by box 110, the processor is configured to determine whether the dwelling is being monitored and if so, lower the risk profile 85 based on the same. The processor is configured to determine whether and track the extent to which the dwelling is being professionally monitored, such as via a third party monitoring service, and adjusts the risk profile in response thereto. The processor is configured to track the extent to which the dwelling sensors are monitored by a person occupying and/or associated with the dwelling. The extent to which the person associated with the dwelling occupies the dwelling (and thus effectively monitors the dwelling) may also be determined by the processor such as via motion sensors and used to lower the risk profile. The extent to which both professional monitoring and self-monitoring are being employed may be determined and used by the processor to further lower the risk profile 85 where such monitoring is present.

This monitoring criteria may also be applied to each of the following components of system 28/28.1/28.2/28.3 described. In this example and as shown by box 112, the processor is configured to determine whether the security alarm system is being monitored and if so lower the risk profile 85. In this example and as shown by box 114, the processor is configured to determine whether the dwelling sensors are being monitored and if so lower the risk profile.

In this example and as shown by box 116, the processor is configured to determine whether minimum and/or above average numbers of dwelling sensors are being monitored and if so lower the risk profile 85 in response thereto. In this example and as shown by box 118, the processor is configured to determine whether a threshold type or set of the dwelling sensors are being monitored and if so lower the risk profile. For example and as shown by box 120, the processor is configured to determine whether one or more water leak sensors are being monitored and if so lower the risk profile 85. The processor in this example is configured to determine the extent to which the one or more water leak detectors are monitored and lower the risk profile based on the same. The processor is configured in this example to determine whether the water leak detector is self-monitored or professionally monitored, such as via a third party monitoring service, and if so, lower the risk profile 85.

In this example and as shown by box 122, the processor is configured to determine whether the smart home devices are being monitored and if so lower the risk profile. The processor is configured to track the extent to which smart home devices are monitored and adjust the risk profile 85 in response thereto. The processor is configured to determine the extent to which the smart home devices are monitored by a person occupying the dwelling and adjust the risk profile in response thereto. The processor is configured to determine whether the smart home devices are professionally monitored, such as via a third party monitoring service, and if so, lower the risk profile 85. In this example and as shown by box 124, the processor is configured to determine whether minimum and/or above average numbers of smart home devices are being monitored and if so lower the risk profile in response thereto. In this example and as shown by box 126, the processor is configured to determine whether a threshold type or set of the smart home devices are being monitored and if so lower the risk profile 85. Specific types of smart home devices whose monitoring thereof may result in a reduced risk profile may include a smart oven and/or a smart refrigerator for example.

In this example and as shown by boxes 128 and 130, the processor is configured to determine whether minimum and/or average above thresholds of monitoring time for a given period are met or exceeded and if so, lower the risk profile 85. In this example and as shown by boxes 132 and 134, the processor is configured to determine whether minimum and/or average above frequencies of monitoring for a given period are met or exceeded and if so, lower the risk profile 85.

The processor is configured to track the extent to which the application software is monitored, including components of system 28/28.1/28.2/28.3, and adjusts the risk profile in response thereto, with more monitoring resulting in a lower risk profile or risk for the insurance broker/company, and thus a higher risk profile score and a discounted insurance premium. The processor is configured to determine whether and track the extent to which the application software is monitored by a person occupying the dwelling and adjust the risk profile in response thereto, with here too more monitoring resulting in a lower risk profile. The processor may determine the extent to which the application software and thus system 28/28.1/28.2/28.3 is monitored based on whether minimum and/or above average thresholds of opening the application software for a given time period are met and if so, lower the risk profile. The processor may determine the extent to which the application software and thus system 28/28.1/28.2/28.3 is monitored based on whether minimum and/or above average thresholds of opening specific screen or web pages of the application software for a given time period are met and if so, lower the risk profile. The processor may determine the extent to which the application software and thus system 28/28.1/28.2/28.3 is monitored based on tracking screen movement of the person's smart phone or other computing device. The processor may determine the extent to which the application software and thus system 28/28.1/28.2/28.3 is monitored by functioning in conjunction with a camera of the smart phone or other computing device to track a person's eyes while the software application is opened. The processor may determine the extent to which the application software and thus system 28/28.1/28.2/28.3 is monitored by determining the extent to which the person logs into the application software for a given time period. The processor may in this example be configured to determine whether the application software is professionally monitored, such as via a third party monitoring service, and if so, lower the risk profile.

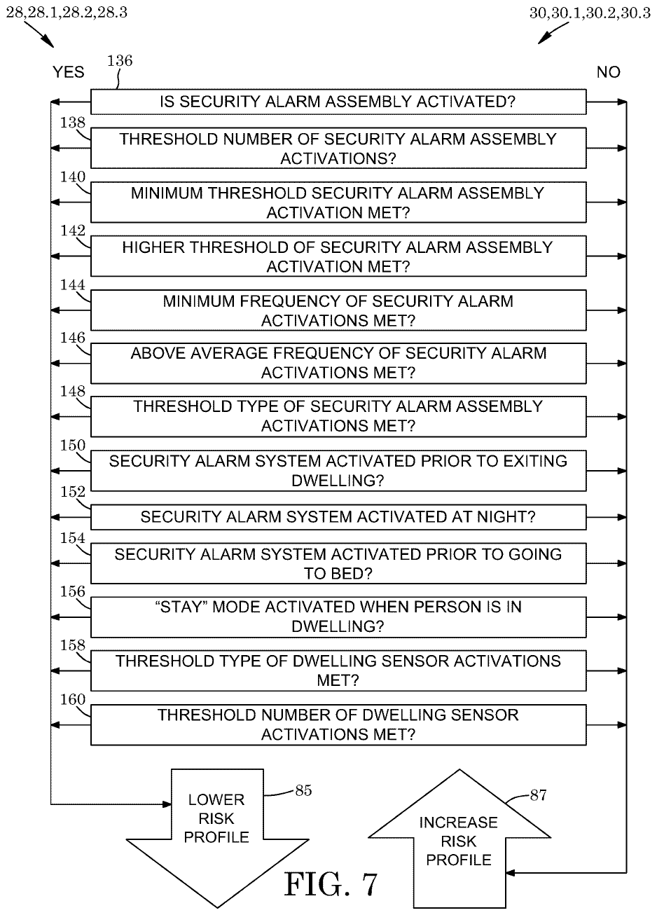

FIG. 7 sets out a non-limiting example of a security assembly activation algorithm which may be used by security alarm assemblies 30/30.1/30.2 set out in FIGS. 1 to 3. In this example and as shown by box 136, the processor is configured to determine the extent to which a security alarm system of the dwelling is activated and adjusts the risk profile in response thereto. In this example and as shown by boxes 138/140/142, the processor is configured to determine whether a threshold, a minimum threshold and/or an above average threshold of security alarm system activations are met for a given period of time and if so, lower the risk profile 85.

In this example and as shown by boxes 146/148, the processor is configured to determine whether minimum and/or above average frequencies of security alarm activations (“stay” mode, “away” mode etc.) are met for a given period of time and if so, lower the risk profile 85. In this example and as shown by box 150, the processor is configured to track the frequency at which the security alarm system is turned on or activated while the person is in the process of exiting the dwelling and adjust the risk profile 85 in response thereto. In this example the processor is configured to lower the risk profile based on the frequency at which the security alarm system is turned on or activated just prior the exiting the dwelling for an extended period of time.

In this example and as shown by box 152, the processor is configured to lower the risk profile based on the frequency at which the security alarm system is turned on or activated at night. In this example and as shown by box 154, the processor is configured in this example to lower the risk profile based on the extent to or frequency at which the security alarm system is turned on or activated prior to the person going to sleep. In this example and as shown by box 156, the processor is configured to determine whether and the extent to which the “stay” mode of the security alarm system is activated when the person is occupying the dwelling.

In this example and as shown by box 158, the processor is configured to determine whether minimum and/or above average thresholds of types of dwelling sensors (or smart home devices) are used/activated and if so, lower the risk profile 85. In this example and as shown by box 160, the processor is configured to determine whether minimum and/or above average thresholds of dwelling sensors (or smart home device) activations/uses occur for a given time period and if so, lower the risk profile. In particular, the processor is configured to determine whether and the extent to which the water leak detector is activated/used, and lower the risk profile 85 based on the same for example.

Processor 54/54.1/54.2 seen in FIGS. 1 to 3 is thus configured to calculate a risk profile based on determinations such as those set out in FIGS. 4 to 6.

Referring to FIGS. 1 to 3, security alarm assemblies 30/30.1/30.2 are configured to send the risk profile or risk profile score so determined to insurance provider 70/70.1/70.2 so as to obtain an insurance quote 72/72.1/72.2 based on the same. Alternatively, the information may be sent to an insurance broker. The security alarm assembly is configured to send the risk profile or risk profile score so determined to the insurance provider and obtain an insurance premium adjustment based on the same. Security alarm assembly 30/30.1/30.2 is configured to determine whether the risk profile or risk profile score so determined is substantially equal to a base line said risk profile and if so, no change in the insurance premium is provided.

An adjusted said risk profile that is less than the base line said risk profile (or a risk profile score that is above a base line risk profile score) may result in a discount in insurance premiums. Security alarm assembly 30/30.1/30.2 is configured to send the risk profile so determined to the insurance provider and obtain a discount on an insurance premium based on the same in this case.

An adjusted said risk profile that is greater than the base line said risk profile (or a risk profile score that is below a base line risk profile score) may result in increased insurance premiums. Security alarm assembly 30/30.1/30.2 in this case may be configured to send the risk profile so determined to the insurance provider and cause the insurer owner to pay or have the option of opting for a higher insurance premium and/or enhanced/increased insurance coverage.

It will be appreciated that many variations are possible within the scope of the invention described herein. Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, mobile devices, security systems and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### Additional Description

Examples of systems and methods of determining a risk profile for a dwelling have been described. The following clauses are offered as further description.
(1) A method of determining a risk profile for a dwelling, the method comprising: determining whether the dwelling is being monitored and adjusting a base line said risk profile in response thereto; determining the type and extent of dwelling sensors within the dwelling and adjusting the risk profile in response thereto; and determining the extent to which a security alarm system of the dwelling is activated and adjusting the risk profile in response thereto.
(2) A method according to clause 1, including determining whether and tracking the extent to which the dwelling is being professionally monitored and adjusting the risk profile in response thereto.
(3) A method according to any one of clauses 1 to 2, including determining whether and tracking the extent to which the dwelling sensors are monitored by a third party monitoring service and altering the risk profile in response thereto
(4) A method according to any one of clauses 1 to 3, including tracking the extent to which the dwelling sensors are used and adjusting the risk profile in response thereto.
(5) A method according to any one of clauses 1 to 4, including tracking the extent to which the dwelling sensors are monitored by a person occupying the dwelling and adjusting the risk profile in response thereto.
(6) A method according to any one of clauses 1 to 4, including tracking the extent to which the security alarm system is monitored by a person occupying the dwelling and adjusting the risk profile in response thereto.
(7) A method according to any one of clauses 1 to 6, including determining the number of said dwelling sensors within the dwelling and adjusting the risk profile in response thereto.
(8) A method according to any one of clauses 1 to 7, wherein the dwelling sensors include at least one of: one or more temperature sensors; one or more motion sensors; one or more optical sensors; one or more cameras; one or more door sensors; one or more window sensors; one or more smoke detectors; one or more carbon monoxide (CO) sensors; one or more water leak sensors; one or more water flow sensors; and one or more humidity sensors.
(9) A method according to any one of clauses 1 to 7, wherein the dwelling sensors include two or more of: one or more temperature sensors; one or more motion sensors; one or more optical sensors; one or more door sensors; one or more window sensors; one or more smoke detectors; one or more carbon monoxide (CO) sensors; one or more water leak sensors; one or more water flow sensors; and one or more humidity sensors.
(10) A method according to any one of clauses 1 to 7, wherein the dwelling sensors comprise: one or more temperature sensors; one or more motion sensors; one or more optical sensors; one or more door sensors; one or more window sensors; one or more smoke detectors; one or more carbon monoxide (CO) sensors; one or more water leak sensors; one or more water flow sensors; and one or more humidity sensors.
(11) A method according to any one of clauses 1 to 7, including determining whether the dwelling sensors include at least one water leak detector and if so, lowering the risk profile.
(12) A method according to clause 11, including determining whether the at least one water leak detector is monitored and if so, lowering the risk profile.
(13) A method according to clause 11, including tracking the extent to which the at least one water leak detector is monitored and adjusting the risk profile based thereon.
(14) A method according to any one of clauses 11 to 13, including determining whether the at least one water leak detector is monitored professionally and if so, lowering the risk profile.
(15) A method according to any one of clauses 11 to 14, including determining the extent to which the at least one water leak detector is monitored by a person occupying the dwelling and adjusting the risk profile in response thereto.
(16) A method according to any one of clauses 11 to 15, including determining the extent to which the at least one water leak detector is used and adjusting the risk profile based on the same.
(17) A method according to any one of clauses 1 to 16, wherein the security alarm system is in communication with the dwelling sensors.
(18) A method according to any one of clauses 1 to 17, including providing an application software in communication with the security alarm system and the dwelling sensors, the application software enabling centralized monitoring of the security alarm system and the dwelling sensors.
(19) A method according to clause 18, including determining whether and tracking the extent to which the application software is used to monitor the dwelling and adjusting the risk profile in response thereto.
(20) A method according to any one of clauses 1 to 19, including adjusting the risk profile based on one or more smart home devices within the dwelling.
(21) A method according to clause 20, including receiving data from the one or more smart home devices within the dwelling and adjusting the risk profile based on the same.
(22) A method according to any one of clauses 1 to 17, including providing an application software in communication with the security alarm system, the dwelling sensors, and one or more smart home devices, the application software enabling centralized monitoring of the security alarm system, the dwelling sensors and the one or more smart home devices.
(23) A method according to any one of clauses 1 to 17, including an application software in communication with the security alarm system, the software enabling the user to one or more of adjust, control or activate one or more of the security alarm system, the dwelling sensors, and one or more smart home devices.
(24) A method according to any one of clauses 20 to 23, including determining the type and extent of said one or more smart home devices within the dwelling and adjusting the risk profile in response thereto.
(25) A method according to any one of clauses 20 to 23, wherein the one or more smart home devices comprise one or more of: smart appliances including one or more of a smart refrigerator and a smart oven; security devices; and lighting systems.
(26) A method according to any one of clauses 1 to 25, including lowering the risk profile based on the frequency at which the security alarm system is turned on while the person is in the process of exiting the dwelling.
(27) A method according to any one of clauses 1 to 26, including lowering the risk profile based on the frequency at which the security alarm system is turned on just prior the exiting the dwelling for an extended period of time.
(28) A method according to any one of clauses 1 to 27, including lowering the risk profile based on the frequency at which the security alarm system is turned on at night.
(29) A method according to any one of clauses 1 to 28, including lowering the risk profile based on the frequency at which the security alarm system is turned on prior to an occupant of the dwelling going to sleep.
(30) A method according to clause 29, including determining when the occupant has gone to sleep based on one or more light and motion detector data.
(31) A method according to any one of clauses 1 to 30, including sending the risk profile so determined to an insurance broker or provider and obtaining an insurance quote based on the same.
(32) A method according to any one of clauses 1 to 30, including sending the risk profile so determined to an insurance provider or broker and obtaining an insurance premium adjustment based on the same.
(33) A method according to any one of clauses 1 to 30, including sending the risk profile so determined to an insurance provider or broker and obtaining a discount on an insurance premium based on the same.
(34) A method according to any one of clauses 1 to 30, wherein the base line said risk profile results in no change in insurance premiums.
(35) A method according to any one of clauses 1 to 30, wherein an adjusted said risk profile that is less than the base line said risk profile results in a discount in insurance premiums.
(36) A method according to any one of clauses 1 to 30, wherein an adjusted said risk profile that is greater than the base line said risk profile results in an increased insurance premiums.
(37) A method according to any one of clauses 1 to 36, including determining whether each of the dwelling sensors is operational and adjusting the risk profile based on the same.
(38) A method according to any one of clauses 1 to 37, including determining whether the dwelling sensors have backup battery power and adjusting the risk profile based on the same.
(39) A method according to any one of clauses 1 to 38, including determining whether any of the dwelling sensors has low battery power or a low battery detector and adjusting the risk profile based on the same.
(40) A method according to any one of clauses 1 to 39, wherein said one or more determinations are made via a processor.
(41) A method according to clause 40, wherein the processor is in communication with or a part of the security alarm system.
(42) A method according to any one of clauses 40 to 41, wherein the processor receives data from and is in communication with the dwelling sensors.
(43) A computer program product comprising a medium carrying computer readable instructions which, when executed by a processor, causes the processor to execute a method according to any one of clauses 1 to 39.
(44) A computer readable storage medium having a program stored thereon, wherein the program code is arranged so that, when the program code is executed by a computer, the steps set out in any one of clauses 1 to 42 are performed.
(45) A security alarm assembly comprising: one or more dwelling sensors; a security alarm system in communication with the one or more dwelling sensors; and a processor configured to determine the number and type of said one or more dwelling sensors, determine the extent to which the security alarm system is activated, determine whether one or more of the security alarm assembly and the dwelling sensors are monitored, and calculate a risk profile based on the same.
(46) A security alarm assembly according to clause 45, wherein the processor is part of the security alarm system.
(47) A security alarm assembly according to clause 45, wherein the processor is part of one or more of a computing device and a mobile device.
(48) A security alarm assembly according to any one of clauses 45 to 48, including an application software, with the one or more dwelling sensors and the security alarm system being capable of being centrally monitored thereby.
(49) A security alarm assembly to any one of clauses 45 to 48, including an application software configured to enable an operator thereof to one or more of adjust, control or activate one or more of the security alarm system, the dwelling sensors, and one or more smart home devices.
(50) A security alarm assembly according to any one of clauses 45 to 48, including a communication module configured to enable the processor to communicate with and receive data from one or more smart home devices.
(51) A security alarm assembly according to any one of clauses 45 to 48, including one or more smart home devices in communication with the security alarm system.
(52) A security alarm assembly according to any one of clauses 45 to 47, including one or more smart home devices in communication with an application software, with the one or more smart home devices being capable of being centrally monitored thereby.
(53) A security alarm assembly according to any one of clauses 49 to 52, wherein the one or more smart home devices are third party devices.
(54) A security alarm assembly according to any one of clauses 49 to 53, wherein the processor is configured to determine the number and type of said one or more smart home devices and adjust the risk profile based on the same.
(55) A security alarm assembly according to any one of clauses 50 to 54, wherein the processor is configured to determine the extent to which the one or more smart home devices are used and adjust the risk profile based on the same.
(56) A security alarm assembly according to clauses 48, 49 and 52, wherein the processor adjusts the risk profile based on whether and the extent to which the application software is used to monitor the dwelling.
(57) A security alarm assembly comprising: one or more dwelling sensors; a security alarm system in communication with the one or more dwelling sensors; and a computing device in communication with the security alarm system so as to enable central monitoring of the security alarm system and components thereof including the one or more dwelling sensors, the computing device determining a risk profile based on the number and type of said one or more dwelling sensors, the extent to which the security alarm system is activated, and the extent to which the computing device is monitored.
(58) A security alarm assembly comprising: one or more dwelling sensors; one or more smart home devices; and a security alarm system in communication with the one or more dwelling sensors and the one or more smart home devices so as to enable central monitoring thereof, the security alarm system determining the number and type of said one or more dwelling sensors, determining whether the security alarm system thereof is monitored, and calculating a risk profile based on the same.
(59) A security alarm assembly according to clause 58, wherein the security alarm system determines the number and type of said one or more smart home devices and adjusts the risk profile based on the same.
(60) A security alarm assembly comprising: a security alarm system; at least one water leak sensor; and a computing device in communication with the security alarm system and the at least one water leak sensor, the computing device determining a risk profile based on the extent to which the security alarm system is activated and based on whether the security alarm system and the at least one water leak sensor are monitored.
(61) A security alarm assembly according to clause 60, wherein the risk profile is adjusted based on a determination via the computing device of the number of said water leak sensors.
(62) A security alarm assembly according to any one of clauses 45 to 61, wherein the risk profile is adjusted based on the extent to which one or more said sensors are monitored.
(63) A security alarm assembly according to any one of clauses 45 to 61, wherein the risk profile is adjusted based on whether and the extent to which each said sensor is monitored.
(64) A security alarm assembly according to any one of clauses 45 to 63, wherein the risk profile is adjusted based on whether the security alarm system is monitored by a third party monitoring service.
(65) A security alarm assembly according to any one of clauses 45 to 64, wherein the risk profile is adjusted based on whether and the extent to which a dwelling is monitored professionally.
(66) A security alarm assembly according to any one of clauses 45 to 64, wherein the risk profile is adjusted based on whether and the extent to which a dwelling is monitored by a person occupying the dwelling
(67) A security alarm assembly according to any one of clauses 45 to 66, including determining whether each of the dwelling sensors is operational and adjusting the risk profile based on the same.
(68) A security alarm assembly according to any one of clauses 45 to 67, including determining whether the dwelling sensors have backup battery power and adjusting the risk profile based on the same.
(69) A security alarm assembly according to any one of clauses 45 to 68, including determining whether any of the dwelling sensors has low battery power or a low battery detector and adjusting the risk profile based on the same.
(70) A security alarm assembly according to any one of clauses 45 to 69, wherein the security alarm assembly is configured to send the risk profile so determined to an insurance provider or broker and obtain an insurance quote based on the same.
(71) A security alarm assembly according to any one of clauses 45 to 69, wherein the security alarm assembly is configured to send the risk profile so determined to an insurance provider so as to obtain one or more of an adjusted, discounted or increased insurance premium based on the same.
(72) A security alarm assembly according to any one of clauses 45 to 69, wherein an adjusted said risk profile that is less than a base line said risk profile results in a discounted insurance premium.
(73) A security alarm assembly according to any one of clauses 45 to 69, wherein an adjusted said risk profile that is greater than a base line said risk profile results in a higher insurance premium.
(74) A computer program product comprising a medium carrying computer readable instructions which, when executed by a processor, causes the processor to execute a method of determining a risk profile for a dwelling, the method comprising: determining whether the dwelling is being monitored and adjusting a base line said risk profile in response thereto; and determining the type and extent of dwelling sensors within the dwelling and adjusting the risk profile in response thereto.
(75) A computer program product according to clause 74, including determining whether and tracking the extent to which the dwelling is being professionally monitored and adjusting the risk profile in response thereto.
(76) A computer program product according to any one of clauses 74 to 75, including tracking the extent to which the dwelling sensors are monitored by a person occupying the dwelling and adjusting the risk profile in response thereto.
(77) A computer program product according to any one of clauses 74 to 76, wherein the dwelling sensors may comprising at least one of: one or more temperature sensors; one or more motion sensors; one or more optical sensors; one or more door sensors; one or more window sensors; one or more smoke detectors; one or more carbon monoxide (CO) sensors; one or more water leak sensors; one or more water flow sensors; and one or more humidity sensors.
(78) A computer program product according to any one of clauses 74 to 76, including determining whether the dwelling sensors include at least one water leak detector and if so, lowering the risk profile.
(79) A computer program product according to clause 78, including determining whether and tracking the extent to which the at least one water leak detector is monitored professionally or by a person occupying the dwelling, and adjusting the risk profile in response thereto.
(80) A computer program product according to any one of clauses 77 to 79, including determining the number of said water leak detectors and adjusting the risk profile in response thereto.
(81) A computer program product according to any one of clauses 77 to 80, including providing an application software in communication with the dwelling sensors, the application software enabling centralized monitoring of the dwelling sensors.
(82) A computer program product according to any one of clauses 77 to 80, including providing an application software in communication with the dwelling sensors, and one or more smart home devices, the application software enabling centralized monitoring of the dwelling sensors and the one or more smart home devices.
(83) A computer program product according to clause 82, wherein the application software is downloaded onto one or more said smart home devices.
(84) A computer program product according to clause 82, wherein the application software is a part of one or more said smart home devices.
(85) A computer program product according to any one of clauses 81 to 84, including determining whether and tracking the extent to which the application software is used to monitor the dwelling and adjusting the risk profile in response thereto.
(86) A computer program product according to any one of clauses 77 to 85, including sending the risk profile so determined to an insurance provider and obtaining an insurance quote based on the same.
(87) A computer program product according to any one of clauses 77 to 86, wherein an adjusted said risk profile that is less than the base line said risk profile results in a discount in insurance premiums and wherein an adjusted said risk profile that is greater than the base line said risk profile results in an increased insurance premiums.
(88) A computer readable storage medium having a program stored thereon, wherein the program code is arranged so that, when the program code is executed by a computer, the following steps are performed: determining whether a dwelling is being monitored and adjusting a base line of a risk profile in response thereto; and determining the type and extent of dwelling sensors within the dwelling and adjusting the risk profile in response thereto.
(89) A computer readable storage medium according to clause 88, including determining whether and tracking the extent to which the dwelling is being professionally monitored and adjusting the risk profile in response thereto.
(90) A computer readable storage medium according to any one of clauses 88 to 89, including tracking the extent to which the dwelling sensors are monitored by a person occupying the dwelling and adjusting the risk profile in response thereto.
(91) A computer readable storage medium according to any one of clauses 88 to 90, wherein the dwelling sensors may comprising at least one or more of: a temperature sensor; a motion sensor; an optical sensor; a door sensor; a window sensor; a smoke detector; a carbon monoxide (CO) sensor; a water leak sensor; a water flow sensor; and a humidity sensor.
(92) A computer readable storage medium according to any one of clauses 88 to 91, including determining whether the dwelling sensors include at least one water leak detector and if so, lowering the risk profile.
(93) A computer readable storage medium according to clause 92, including determining whether and tracking the extent to which the at least one water leak detector is monitored professionally or by a person occupying the dwelling and adjusting the risk profile in response thereto.
(94) A computer readable storage medium according to any one of clauses 92 to 93, including determining the number of said water leak detectors and adjusting the risk profile in response thereto.
(95) A computer readable storage medium according to any one of clauses 88 to 94, including providing an application software in communication with the dwelling sensors, the application software enabling centralized monitoring of the dwelling sensors.
(96) A computer readable storage medium according to any one of clauses 88 to 94, including providing an application software in communication with the dwelling sensors, and one or more smart home devices, the application software enabling centralized monitoring of the dwelling sensors and the one or more smart home devices.
(97) A computer readable storage medium according to clause 96, wherein the application software is one or more of: downloaded onto the one or more said smart home devices; and a part of the one or more said smart home devices.
(98) A computer readable storage medium according to any one of clauses 95 to 97, including determining whether and tracking the extent to which the application software is used to monitor the dwelling and adjusting the risk profile in response thereto.
(99) A computer readable storage medium according to any one of clauses 88 to 98, including sending the risk profile so determined to an insurance provider and obtaining an insurance quote based on the same.
(100) A computer readable storage medium according to any one of clauses 88 to 99, wherein an adjusted said risk profile that is less than the base line of the risk profile results in a discount in insurance premiums and wherein an adjusted said risk profile that is greater than the base line of the risk profile results in an increased insurance premiums.
(101) Apparatus including any new and inventive feature, combination of features, or sub-combination of features as described herein.
(102) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method of determining a risk profile for a dwelling, the method comprising:
determining whether the dwelling is being monitored and adjusting the risk profile from a base line in response thereto;
determining the type and extent of dwelling sensors within the dwelling and further adjusting the risk profile in response thereto;
determining the extent to which a security alarm system of the dwelling is activated and yet further adjusting the risk profile in response thereto; and
sending the risk profile so determined to an insurance provider or broker and obtaining an insurance quote based on the same.

2. A method according to claim 1, wherein the risk profile is determined without providing to the insurance provider any specific data related thereto.

3. A method according to claim 1, including making said determinations via a processor situated within the dwelling.

4. A method according to claim 1, including determining whether and tracking the extent to which the dwelling is being professionally monitored, monitored by a third party monitoring service and/or monitored by a person occupying the dwelling, and adjusting the risk profile in response thereto.

5. A method according to claim 1, including: determining the number of said dwelling sensors within the dwelling and/or tracking the extent to which said dwelling sensors are used; and adjusting the risk profile in response thereto.

6. A method according to claim 1, including determining whether each said dwelling sensor is operational, has backup battery power and/or has a low battery/battery-power detector, and adjusting the risk profile based on the same.

7. A method according to claim 1, including: determining whether the dwelling sensors include at least one water leak detector and if so, lowering the risk profile; and tracking the extent to which the at least one water leak detector is monitored and/or used, and adjusting the risk profile based thereon.

8. A method according to claim 1, including: providing an application software in communication with the security alarm system, the dwelling sensors and one or more smart homes devices within the dwelling, the application software enabling centralized monitoring of the security alarm system, the dwelling sensors and the one or more smart home devices; and determining whether and tracking the extent to which the application software is used to monitor the dwelling and adjusting the risk profile in response thereto.

9. A method according to claim 1, including: lowering the risk profile based on the frequency at which the security alarm system is turned on while a person is in the process of exiting the dwelling; lowering the risk profile based on the frequency at which the security alarm system is turned on at night; and/or lowering the risk profile based on the frequency at which the security alarm system is turned on prior to an occupant of the dwelling going to sleep.

10. A method according to claim 1, including: obtaining an insurance premium adjustment from the insurance provider or broker based on the risk profile; obtaining a discount on the insurance premium from the insurance provider or broker based on the risk profile; and/or wherein the base line said risk profile results in no change in one or more insurance premiums, wherein an adjusted said risk profile that is less than the base line said risk profile results in a discount in one or more insurance premiums, and wherein an adjusted said risk profile that is greater than the base line said risk profile results in an increased insurance premium.

11. A security alarm assembly comprising:
one or more dwelling sensors;
a security alarm system in communication with the one or more dwelling sensors; and
a processor configured to determine the number and type of said one or more dwelling sensors, determine the extent to which the security alarm system is activated, determine whether one or more of the security alarm assembly or the one or more dwelling sensors are monitored, and calculate a risk profile based on the same;
wherein the security alarm assembly is configured to send the risk profile so determined to an insurance provider or broker and obtain an insurance quote based on the same.

12. A security alarm assembly according to claim 11, including a communication module configured to enable the processor to communicate with and receive data from one or more smart home devices, with the processor being configured to calculate the risk profile in part based thereon.

13. A security alarm assembly according to claim 12, wherein the processor is configured to adjust the risk profile based the number and type of the one or more smart home devices, the extent to which the one or more smart homes devices are monitored, and/or the extent to which the one or more smart home devices are used.

14. A security alarm assembly according to claim 12, wherein the one or more dwelling sensors comprise a temperature sensor, a motion sensor, an optical sensor, a door sensor, a window sensor, a smoke detector, a carbon monoxide (CO) sensor, a water leak sensor, a water flow sensor and/or a humidity sensor, and wherein the one or more smart home devices comprise a smart hub, a smart refrigerator, a smart air conditioning system, a smart oven, a smart cooker, a smart shower, a smart mattress, a smart thermostat, a smart speaker, a smart display, a smart doorbell, a smart lock, a smart plug, and/or a smart lighting system.

15. A security alarm assembly according to claim 12, wherein the one or more dwelling sensors comprise at least one water leak sensor, with the risk profile being adjusted based on a determination via the processor of whether and/or the extent to which the at least one water leak sensor is monitored and/or used.

16. A security alarm assembly according to claim 12, wherein the assembly is configured to create of a geofence and/or a virtual perimeter about a person's dwelling or property, with the processor being configured to selectively communicate with and/or ping various components of the assembly based on whether a designated said person enters or exits the geofence, with the processor making determinations and/or communicating information to the person, based on the same.

17. A security alarm assembly according to claim 12, wherein the assembly includes a sliding risk scale within/along which a given said risk profile is determined/adjusted.

18. A computer program product comprising a medium carrying computer readable instructions which, when executed by a processor, causes the processor to execute a method of determining a risk profile for a dwelling, the method comprising:
determining whether the dwelling is being monitored and adjusting a base line said risk profile in response thereto;
determining the type and extent of dwelling sensors within the dwelling and further adjusting the risk profile in response; and
sending the risk profile so determined to an insurance provider and obtaining an insurance quote based on the same.

19. A computer program product according to claim 18, including determining whether the dwelling sensors include at least one water leak detector and if so, lowering the risk profile, determining whether and tracking the extent to which the at least one water leak detector is monitored professionally or by a person occupying the dwelling, and adjusting the risk profile in response thereto, and/or determining the number of said water leak detectors and adjusting the risk profile in response thereto.

20. A computer program product according to claim 18, comprising an application software in communication with the dwelling sensors, a security alarm system and one or more smart home devices, with the application software enabling centralized monitoring of the dwelling sensors, the security alarm system and the one or more smart home devices, with the computer program product adjusting the risk profile in part based on the number and type of said one or more smart home devices and/or based on the extent to which said security alarm system and/or one or more smart homes devices are monitored.
